(19) United States
(12) Patent Application Publication
(10) Pub. No.: US 2015/0342383 A1
(43) Pub. Date: Dec. 3, 2015

(54) HANGER

(71) Applicants: Marlin Gilbert, San Francisco, CA (US); Richard Montauk, Boston, MA (US)

(72) Inventors: Marlin Gilbert, San Francisco, CA (US); Richard Montauk, Boston, MA (US)

(21) Appl. No.: 14/656,716

(22) Filed: Mar. 13, 2015

(30) Foreign Application Priority Data
May 30, 2014 (GB) 1409688.7

(51) Int. Cl. A47G 25/14; F16M 13/02

(52) U.S. Cl. CPC A47G 25/14; F16M 13/02

(57) ABSTRACT

A hanger includes a grip arranged at a first end. The grip is configured to be mounted over a transverse elongate member thereby removably securing the hanger thereon. An intermediate body extends away from the grip; and a catch extends from the intermediate body, arranged at a second end opposite the first end. The catch being configured to receive an item to be hung therefrom; and the catch includes a narrowed portion.

### FIELD OF THE INVENTION

The present invention relates to a hanger, in particular a hanger for garments; more particularly but not exclusively a rail hanger configured for temporarily hanging garments away from the rail.

### BACKGROUND

In many guest houses, hotels or other places of temporary accommodation antitheft clothes hangers have been in use since the mid 20^{th} century, and are designed to minimise users of the accommodation taking these clothes hangers with them for use at home.

Such clothes hangers are typically designed for use on a particularly rail and the user is unable to use the clothes hanger elsewhere, even in the same accommodation. This can be restrictive unless the user has brought a standard clothes hanger to the accommodation.

This is of particular concern in relation to standard needs related to temporary accommodation, which often include formal—or at least unwrinkled—clothing requirements, combined with inadequate ironing facilities, even where ironing is appropriate to the clothing. Users need to look neat and presentable the next day. Ironing is not appropriate for suit coats, most dresses, and virtually anything made of wool, silk, and other fibres.

For example therefore, the user frequently wishes to hang a garment in an area such as a shower or bathroom, where the garment can receive a steaming to make the garment more suitable for wearing.

Users consequently must wear crumpled or creased clothing or jerry-rig temporary hanging arrangements, which is highly unsatisfactory and may be liable to lead to garments falling on the floor and dirtying, as well as associated time-pressures.

Accordingly a number of patent applications have been filed in an attempt to resolve the problem or similar, including the following:

European patent application EP 1 544 136 (SCHNEUING) comprises an adapter hook for conveyor systems, especially for garments, with an upper suspension, which can be hung from a rail or a conveyor mechanism for the transport of objects, and a lower holding mechanism, by means of which one or more hangers can be received, wherein the lower holding mechanism has a swivel lever for the receiving of one or more hangers, which can be secured by a locking mechanism

Granted U.S. Pat. No. 7,793,808 (HERMAN et al) discloses a stackable garment hanger comprising: a pole hook including a pole hook member and a first hanger retaining member extending from said pole hook member, said first hanger retaining member includes a first pair of spaced apart upright hooks, said first pair of spaced apart upright hooks include a pair of first bottom receivers formed on a bottom of said thereof; and at least one hanger member, each one of said at least one hanger member including a garment retaining member, a second hanger retaining member, an extension member and a retaining rod, said second hanger retaining member extending from a top of said garment retaining member, one end of said extension member extending upward from said second hanger retaining member, said retaining rod extending from the other end of said extension member, said retaining rod having a substantially horizontal orientation, said first pair of bottom receivers being sized to receive said retaining rod, said second hanger retaining member being sized to receive said retaining rod

In contrast the present invention provides a cost-effectively produced, clean and simple to use means of temporarily hanging garments.

### SUMMARY

According to a first aspect of the present invention there is provided a hanger comprising: a grip arranged at or adjacent the end of a body, wherein the grip is configured to progressively engage over a transverse elongate member so as to maintain the hanger on the member; an intermediate body; and a catch for hanging items below the hanger; wherein said catch comprises a narrowed portion.

### BRIEF DESCRIPTION OF FIGURES

The following detailed description of the preferred embodiment of the present invention will be better understood when read in conjunction with the appended drawings. For the purpose of illustrating the invention, there are shown in the drawings embodiments, which are presently preferred. It is understood, however, that the invention is not limited to the precise arrangements and instrumentalities shown. In the drawings:

FIG. 1 shows an isometric view of a preferred embodiment of a hanger according to the present invention in use with a clothes hanger;

FIG. 2 shows an isometric view of the hanger shown in FIG. 1;

FIGS. 3a and 3b show a side and front view, respectively, of the embodiment in use with a clothes hanger, as shown in FIG. 1;

FIG. 4 shows a plan view of the embodiment in use with a clothes hanger, as shown in FIG. 1;

FIGS. 5a and 5b show top and bottom plan views of the embodiment of the hanger shown in FIG. 1;

FIGS. 6a-6c show front, side and rear views of the hanger as shown in FIG. 1;

FIG. 7 shows a sketch view of a second embodiment of the hanger according to the present invention;

FIGS. 8a-8d show sketch views of a third embodiment of the hanger according to the present invention; and

FIGS. 9a and 9b show sketch views of a fourth embodiment of the hanger according to the present invention.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

Applicant has identified that known antitheft cloths hangers do not include hooks, so as to prevent their use without the rail from which they depend in use. The hook is replaced with a stud, and the stud is seated in a channel on the underside of a rail in the relevant furniture in the accommodation. The stud and rail interface is of sufficient strength to withstand gravitational forces on a laden clothes hanger. This however means that the clothes hangers are only of use on the accommodation's rail and the user is unable to use the clothes hanger elsewhere, even in the accommodation. This can be restrictive unless the user has brought a standard clothes hanger to the accommodation.

According to one approach, there is provided a hanger comprising a grip arranged at or adjacent the end of a body. The grip is configured to progressively engage over a transverse elongate member so as to maintain the hanger on the member. An intermediate body and a catch for hanging items below the hanger is provided. The catch comprises a narrowed portion.

In some embodiments, the hanger is comprised of a single part comprising a body arranged to provide an upper grip and lower catch at or adjacent its ends.

Upwards and downwards are herein described with reference to relative vertical placement in use but may describe horizontal placement in other arrangements.

In some embodiments, the catch and grip are vertically displaced in use, wherein the item hanging lowermost is displaced by the body.

In some embodiments, the hanger comprises a continuous form, for example having a twisting or curved form. As a single body part the hanger is cost-efficient to produce, and compact for transport.

Advantageously, this form allows the hanger to have no corners or dirt accumulation areas.

Preferably, the hanger is composed of heat and moisture resistant plastics. In this way, passing through airport security is greatly facilitated. Ideally the hanger comprises single shot moulding in plastics with a glossy surface over at least part.

Advantageously such a style of hanger is resistant to moisture accumulation, also clean in usage, and easy to wipe clean.

In some embodiments, said catch is configured to accept a rod and distal stud as found in hotel or anti-theft clothes hangers commonly found in hotels or guest houses.

The hanger thereby combines with such clothes hangers to allow a user to temporarily place the hanger, for example in or near a shower or bathroom, at a stall, or wall feature or on a rail; in order that a garment may be steamed by moisture or dried by air circulation around it.

Preferably, the stud and rod are held with minimal chance of movement when the clothes hanger is in place, wherein the garment thereon will be hung vertically stably, in this way the hanger may be placed in a temporary situation confidently, without concerns as to dislodging or falling.

In some embodiments, the grip is not arranged to rotate or twist on the member in use, being engaged along a section of the member, wherein to twist thereon would require tilting. Tilting is prevented by an enlarged engagement and ideally close fitting about the member, furthermore limiting likelihood of displacement of loose garments off clothes hangers or similar.

The grip provides a continuous arcuate member engagement area, allowing variation of engagement or contact points, variation of the hanging axis and gravitational forces pivoted about the member. Such area typically describes an arcuate or radiused internal face curving away from the body through over 90 degrees.

In some further embodiments the member engagement area may be multiplanar, and/or allowing or providing incremental contact points.

In this way even in low visibility or steamy conditions preventing spectacle-wearing the user can be sure to hang the clothes hanger without risking dropping the clothes hanger or garment or dislodging the hanger.

In some embodiments, however the catch allows or is configured to allow settling and/or rotation of the item with respect to the member. For example in preferred embodiments the portion has a periphery leaving sufficient turning space for the stud to turn freely, and wherein the portion comprises or is covered by a friction-reducing material.

The grip and body may have a textured internal or rear face or raised and lowered parts to encourage friction, in order to, for example, facilitate deliberate removal of the item.

Advantageously rotation of the item is easier to control and manipulate, and so it is made easier to place the clothes hanger according to preference or situation.

Advantageously therefore the hanger may be envisaged to be ideally used in a bath or shower room situation, where any garment hung on the clothes hanger is subjected to steam and movement to have creases removed, where however, at the same time falling into water being undesirable.

Advantageously in some embodiments the catch may be usable as a hook for items such as garments directly.

In some embodiments the catch may comprise shaping configured for the stud.

In some embodiments, the catch comprises a wider upper area with a lower narrower portion. In some embodiments this comprises an entrance into which the rod and stud are initially passed, with gravity acting on the stud to pull it into or against the portion.

In some embodiments the catch comprises a slit, wherein the entrance is provided substantially horizontally to one side of the slit and the portion may comprise a hole sized smaller than the stud but larger than the rod.

In all preferred embodiments the item progressively enters the catch.

In some embodiments, the catch comprises a cleft descending or tapering substantially vertically towards a narrower portion arranged for seating the stud in use. In this way, the user is enabled to guide and/or drop the rod and stud into the cleft, wherein gravity acts to pull the stud against the portion, cleft or other relevant body area.

In some further embodiments cleft and catch are shaped to provide a narrowed portion that extends around more than one plane, so as to allow a variable axis of hanging according to the item, describing a radial arc according to gravitational forces acting with the grip as centre.

For example in some embodiments the portion may describe a number of contact points about a continuous radial arc, on the catch and/or body, so as to provide an internal radiused or arcuate face; ideally facing an opposing direction to the member engagement area, advantageously so as to space apart the item from the member in hanging.

In some embodiments the catch and grip are substantially horizontally displaced by a spacer body in order that horizontal displacement from a member comprising a vertically extending member is achieved as well as vertical displacement from a free running member. In preferred embodiments in use a hanging axis is defined between the catch and grip, ideally definable vertically in use by gravitational force on the item acting to alter engagement of the grip on the member and deviate the axis.

The catch and grip are displaced to either side of a core axis defined by the body, wherein the core axis is at an angle to the hanging axis.

According to a second aspect of the present invention there is provided a two-part hanging system comprising a clothes hanger and hanger as described herein.

With reference to the accompanying figures there is provided a single-shot single piece moulded plastics hanger 12, having a wider uppermost grip 2, a tapering intermediate body 1, such being the intermediate plastics portion between the grip 2 and a lowermost or distal catch 3. The grip and catch project or extend away from the body in opposing directions and comprise hemi- or semi-spherical arcs. The faces of the grip 2 and catch 3 describe continuous surfaces through 180 degrees, elongated so as to internally describe half a length of a cylinder.

The hanger 12 is primarily used with antitheft clothes hangers similar to that pictured and known as 20.

The intermediate body 1 substantially follows a core axis, which intersects to a lesser or greater degree with a hanging axis described between the catch 3 and grip 2 in use.

The clothes hanger is similar to known clothes hangers having a vertical hanging axis in use with extending and inclined arms therefrom; with rod 21 and stud 22 extending upwards in use for engagement with a channel in a hanging rail.

The hanger 12 is formed of polyethylene or acrylonitrile butadiene styrene or polymer in an injection-moulded continuous unbroken part, largely forming an S shape in side view.

The catch 3 is configured to receive the stud 22 and rod 21 of an antitheft clothes hanger with a vertical narrowing cleft 7 between two tabs 5 leading to a lowermost portion extending parallel to the grip.

The catch 3 has upward extending tabs 5, which flank and extend up from the narrowed portion and incline away from the body as well as widening. These tabs 5 guide the stud 22 and aid a user to insert the rod 21 into the catch 3 through the cleft 7.

The tabs 5 in the pictured embodiment flare upwards to additionally provide a hanging point for an item comprising a garment without a clothes hanger, allowing dual-purpose use of the hanger 12.

The cleft 7 has a rounded entrance 11, through which passes the rod 21, and stud 22. The tabs 5 project away from the body to guide the stud 22 into the narrow portion 6. In some further embodiments in addition or the alternative the cleft may progressively narrow away from the entrance and towards the portion.

The tabs 5, cleft 7 and hanger 12 in general additionally have chamfered or rounded edges 10 so as to further aid use, as well as avoid snag hazards in transport or storage.

The hanger 12 is configured with a twisting body providing a catch 3 and grip 2 facing in opposing directions. The catch 3 is projected away from the grip 2 by the body 1, in this way the clothes hanger 20 is ideally spaced apart from the member at all times as rotating under gravity.

Such serpentine form ideally provides structural strength in addition or the alternative, both in use with heavy items and as a guard against crushing in transport.

Ideally, the form also allows multiple hangers to be transported, stored or displayed in stack arrangement stacked front face 100 to back face 101. In some embodiments the back face is texturised, pimpled, rubberised or has raised and lowered parts encouraging grip, and the front face 100 is glossy, for clean contact points. The always-visible front face 100 can also include logos or other indicia.

The catch 3 comprises a narrowing profile, with a narrowest portion 6 lowermost in use and extending transversely across the lowermost portion of the hanger 12 and spacing the tabs 5 from the body. In this way the rod 21 of a clothes hanger may be easily introduced into the catch and the clothes hanger stud 22 prevented from further downwards movement under gravity by being seated in the portion 6. The portion is recessed appropriately sized for a stud 22 of an antitheft clothes hanger 20, to allow it to rotate therein but not to permit it to pass through.

Chamfered edges 10 to the portion and the tabs' angle of projection away from the body ensure that the stud 22 remains at or adjacent the portion even when the hanger 12 has adjusted under gravity, for example so as to bring the stud 22 vertically below a free running rod or rail 13 over which the grip 2 is engaged.

The grip 2 is shaped with a concave shaping for engagement over such items as a shower rail, curtain rod, etc. The grip 2 is formed by two quarter segment cylindrical parts describing matching arcs 8 configured to engage over the rail 13, and a tail 4 arranged to extend beyond the rail 13 and minimise chances of dislodging of the hanger 12 from the rail 13.

The tail 4 furthermore ensures that a greater variation in hanging axes is possible. Such shaping, further enables the grip 2 to engage over other elongate members such as a cubicle wall or screen, as commonly found in bathrooms, wherein the concave shaping provides an elongated contact.

In some further embodiments, discussed below, the shaping may comprise variant parts, for example a concave part and planar part, and/or square or rectangular members; so as to enable members such as shower screens, closet or cabinet doors to be utilised.

When engaged over planar members and vertically depending members, the shaping tends the hanger to pivot the catch on the member.

A tail 4 extends further than the engagement of the grip 2 to ensure that the hanger 12 is not liable to dislodge under excessive rotation of the grip 2 about the member.

The tail 4 and body 1 present a vertically narrowing grip 2, being spaced further apart to guide the grip 2 onto member.

The grip 2 is sufficiently wide to maintain a strong stable grip over the member and so aid in ensuring that the user is enabled to confidently place the clothes hanger 20 into the catch 3 without dislodging the grip 2.

The grip 2 provides a continuous arcuate member engagement area, admitting variation of engagement or contact points, under variation of the hanging axis.

The grip 2 may comprise a degree of deformable resilience or flexibility, so as to enable the grip to bias against the member in use; wherein for example the grip describes an arcuate face of over 180 degrees.

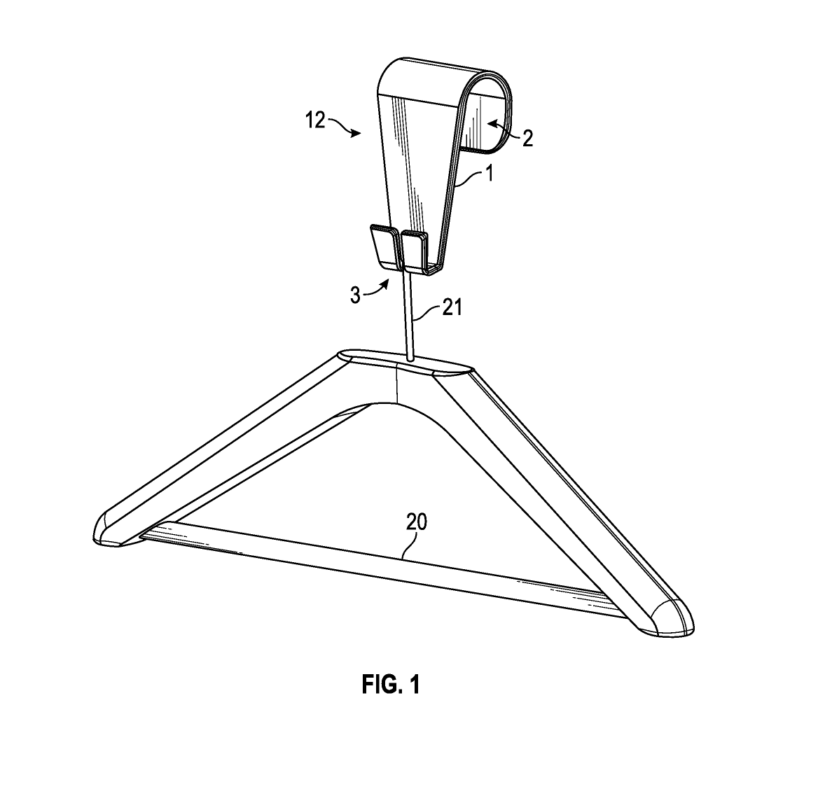

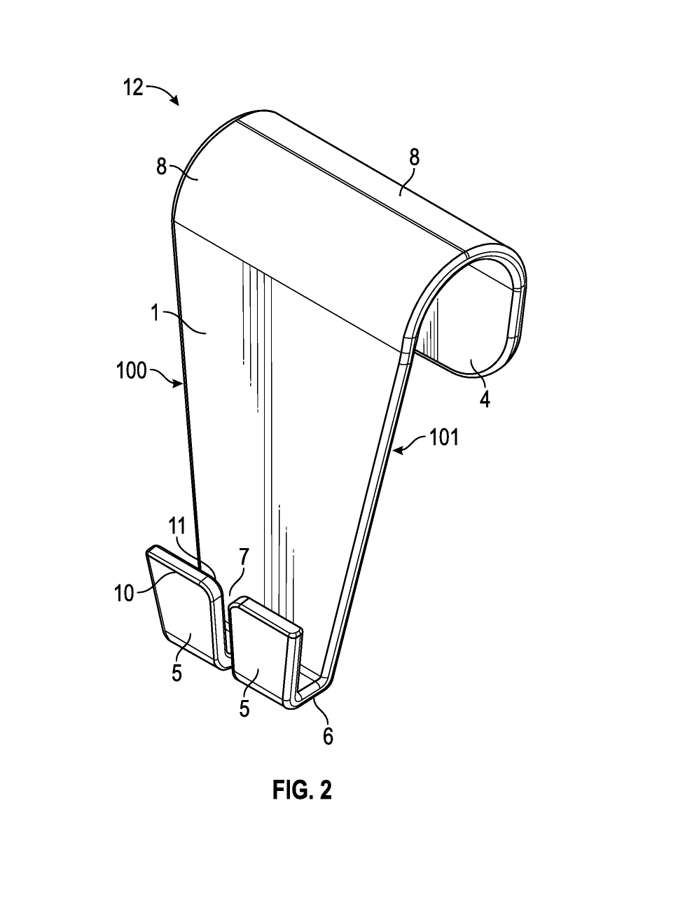

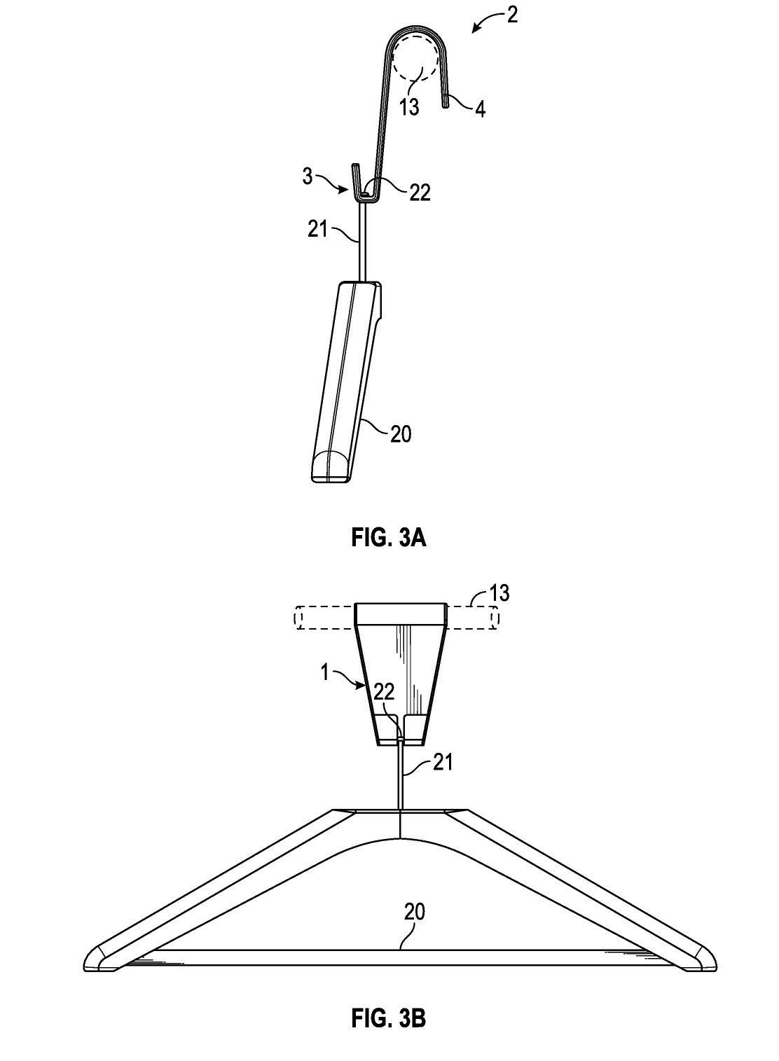

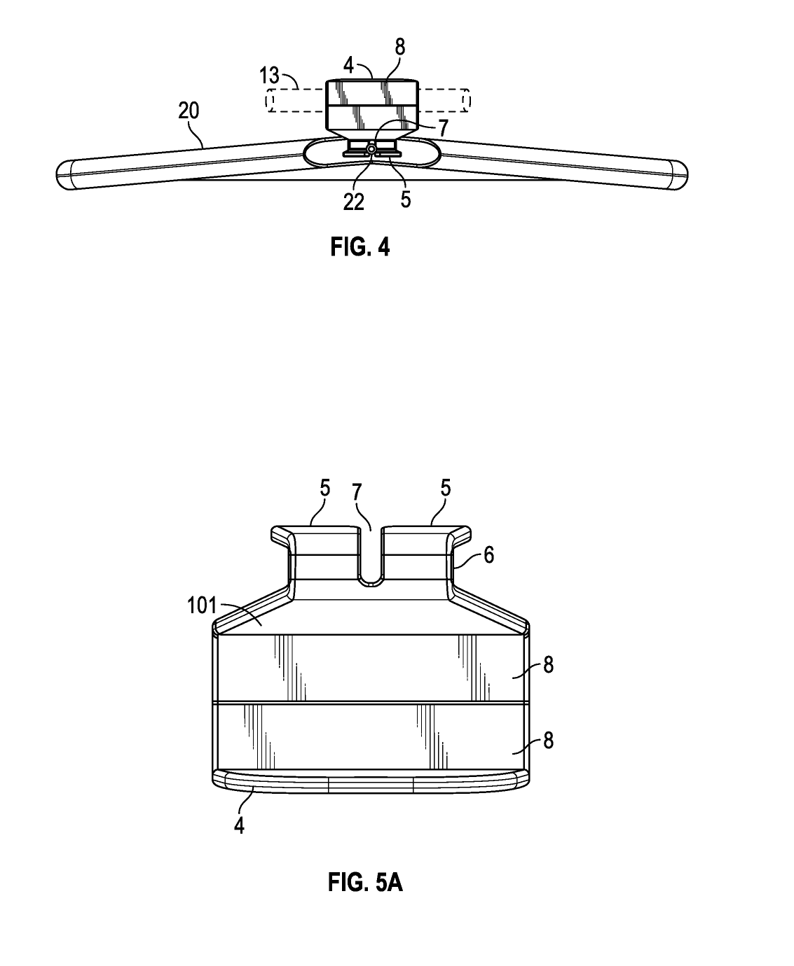

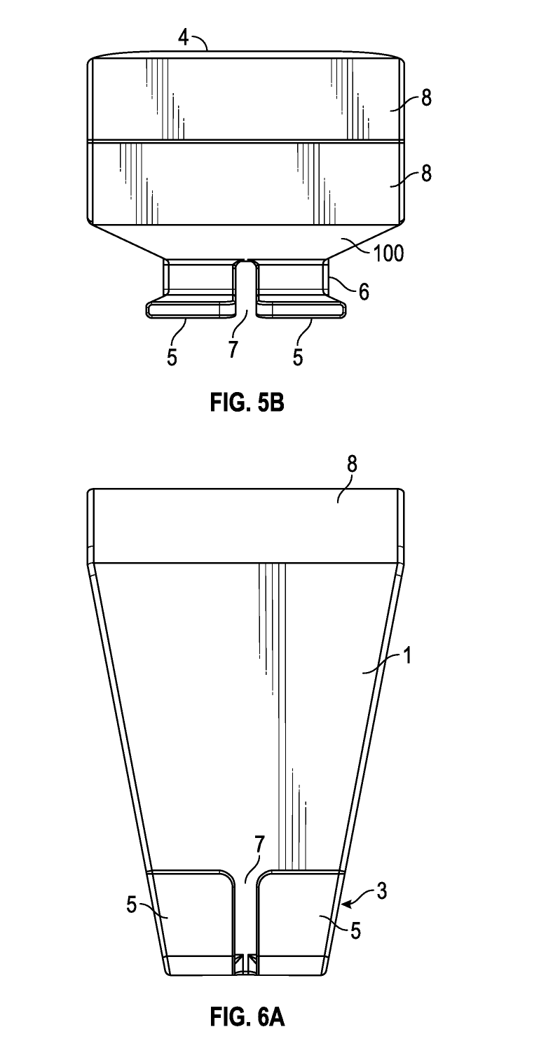

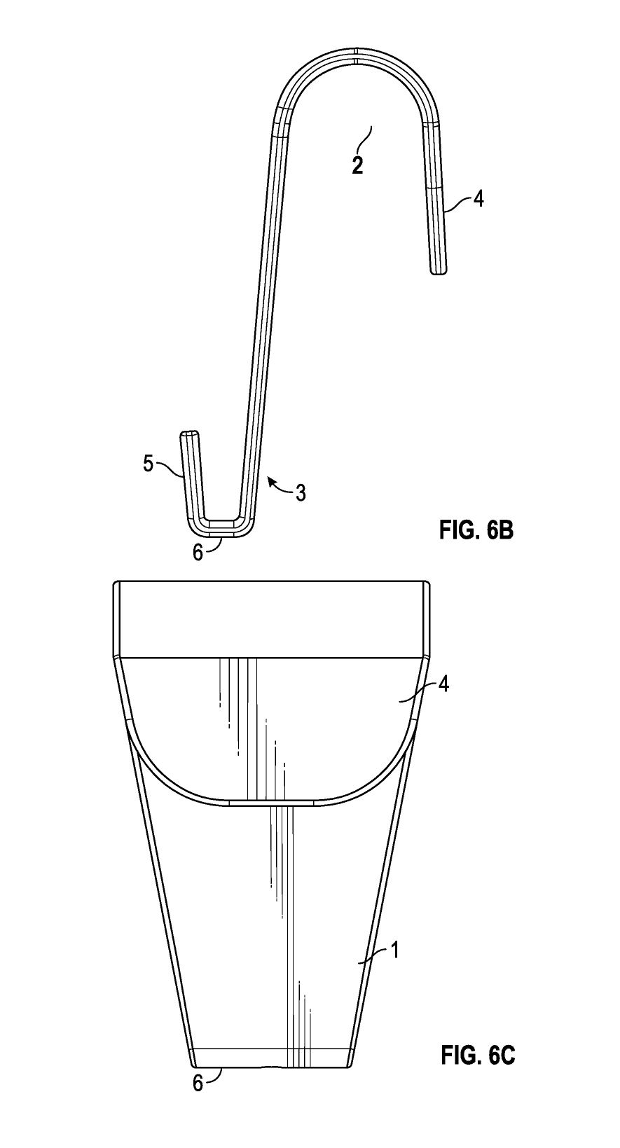

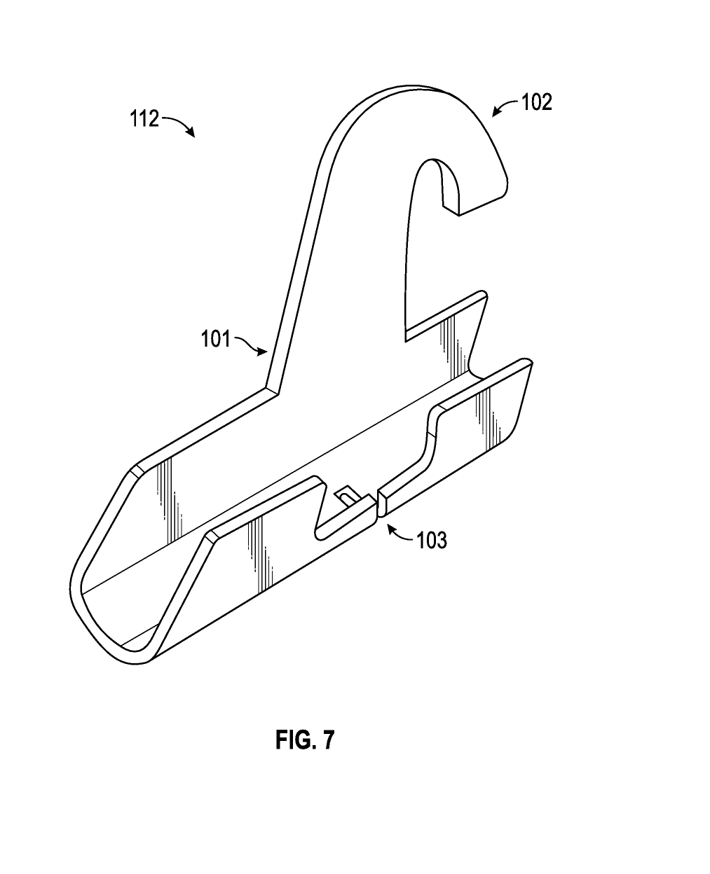

As depicted in FIG. 7, the hanger 112 includes a grip 102, which is configured to perpendicularly engage a hanging member. The intermediate body 101 and the catch 103 are spatially arranged in a similar fashion as in the embodiments shown in FIGS. 1-6. The hanger 112 of the embodiment shown in FIG. 7 allows for space saving, permitting more room to hang multiple hangers 112 next to each other. Further, the narrower grip 102 engaging portion could effectively be used with drying lines, which are often found in hotel bathrooms.

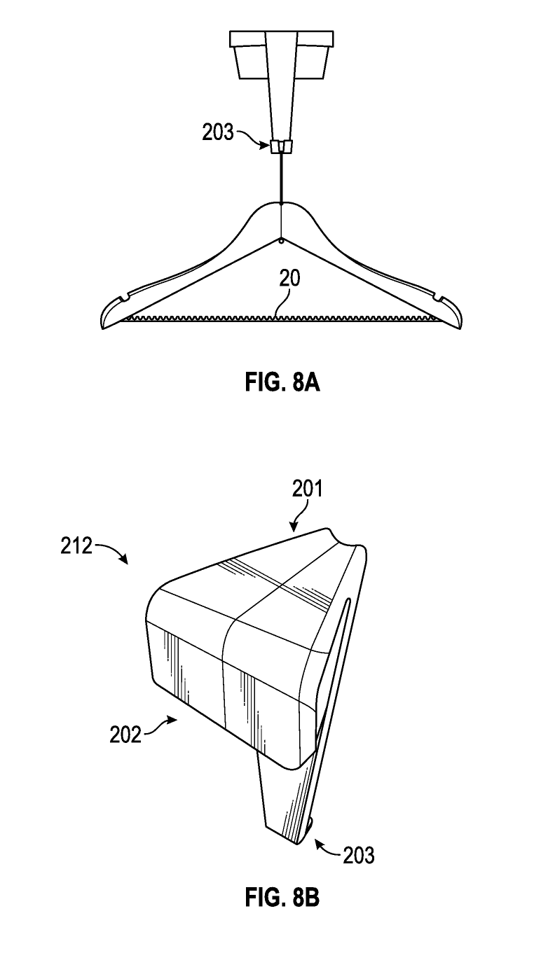

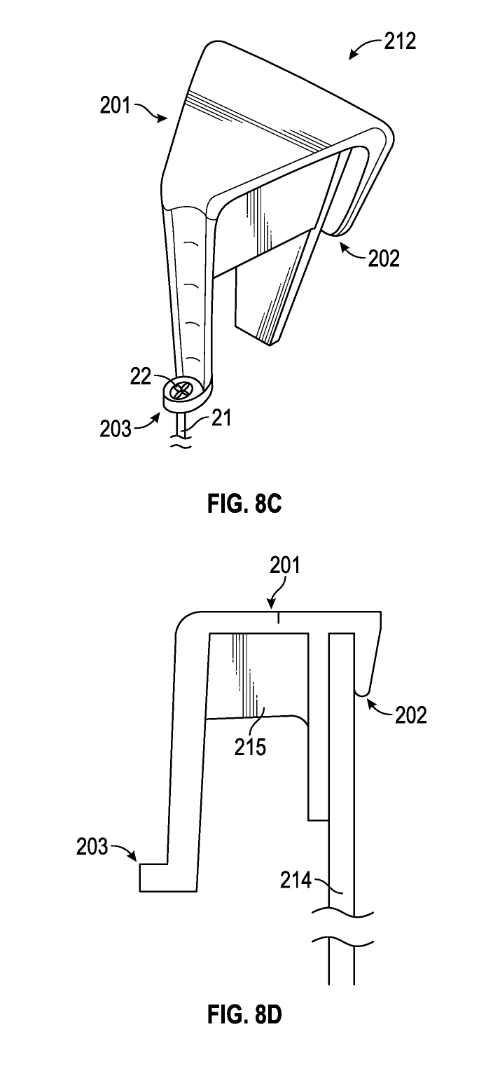

The embodiment shown in FIG. 8 is particularly configured for the hanger 212 to grip onto a planar sheet such as a shower screen 214, the catch 203 spaced apart by a spacer body 215 to a grip 202 with bipartite planar parallel parts. Such parts may include rubber or friction providing material, in order that the hanger 212 is not liable to transverse movement even during engagement with the clothes hanger 20.

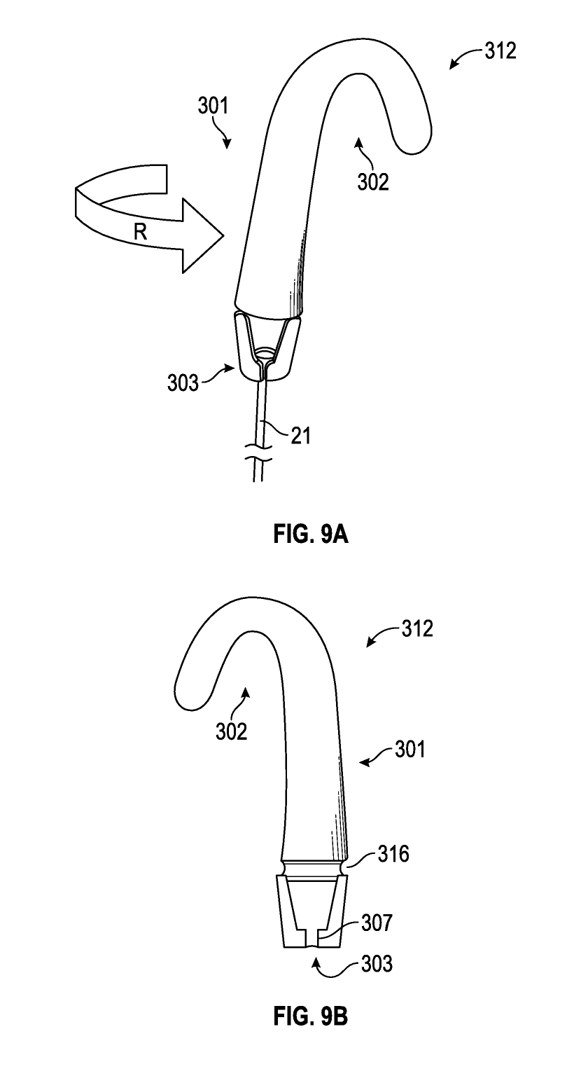

The hanger 312 of the embodiment shown in FIG. 9 includes a catch 303 that is able to rotate R on the body 301 by means of a pivot portion 316. As in the above embodiments, the catch 303 includes a cleft 307. The catch can be attached onto the body 301 by a snap fit at the pivot portion 316. The catch 303 is roatable with reference to the body 301 owing to the grip 302 being fixed with reference to the body 301. In this way variant supporting members or hanging situations may be accommodated.

The invention has been described by way of examples only and it will be appreciated that variation may be made to the above-mentioned embodiments without departing from the scope of invention. Firstly it will be understood that any features described in relation to any particular embodiment may be featured in combinations with other embodiments.

With respect to the specification therefore, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention, with variation and implementation obvious and clear on the basis of either common general knowledge or of expert knowledge in the field concerned. Further, since numerous modifications and changes will readily occur to those skilled in the art, it is not desired to limit the invention to the exact construction and operation shown and described, and accordingly, all suitable modifications and equivalents may be resorted to, falling within the scope of the invention as set out in the accompanying claims.

1. A hanger comprising:
a grip arranged at a first end, wherein the grip is configured to be mounted over a transverse elongate member thereby removably securing the hanger thereon;
an intermediate body extending away from the grip; and
a catch extending from the intermediate body, arranged at a second end opposite the first end, the catch being configured to receive an item to be hung therefrom; and
wherein said catch comprises a narrowed portion; and
wherein said catch further comprises a cleft descending or tapering substantially vertically towards a portion recessed for seating an antitheft clothes hanger stud.

2. The hanger according to claim 1, wherein the hanger is of a unibody configuration.

3. The hanger according to claim 1 wherein the hanger comprises a continuous form.

4. The hanger according to claim 3 wherein the form comprises a stackable curved form.

5. The hanger according to claim 4 wherein the form comprises at least one internal arcuate face.

6. The hanger according to claim 3 wherein the form comprises two arcuate faces extending away from the body in opposing directions.

7. The hanger according to claim 1 wherein the hanger is entirely formed in heat and moisture resistant plastics.

8. The hanger according to claim 1 wherein the catch is configured to accept a rod and distal stud such as found in hotel or anti-theft clothes hangers.

9. The hanger according to claim 8 wherein the catch comprises shaping configured to accept the stud.

10. The hanger according to claim 1 wherein the grip is arranged so as not to rotate or twist on the member in use, engaging along a section of the member generally corresponding to body length.

11. The hanger according to claim 1 wherein the grip is resiliently deformable so as to allow the grip to be biased onto a member.

12. The hanger according claim 1 wherein the catch is rotatable with respect to the intermediate portion and the grip.

13. A hanger according to claim 1 wherein the catch comprises tabs that flare outwards away from a lowermost portion of the catch thereby defining a hanging portion for garment items.

14. The hanger according to claim 1 claim wherein the catch comprises an entrance leading past flanking intermediate tabs to a narrower portion.

15. (canceled)

16. The hanger according to claim 1 wherein a hanging axis as defined between the catch and grip is generally vertical in use by gravitational forces.

17. The hanger according to claim 16 wherein the grip has an internal face comprising two matching arcs extending along the member in use.

18. The hanger according to claim 1 wherein the body deviates from the hanging axis.

19. The hanger according to claim 17 wherein a hanging axis defined between the catch and grip differs from and permanently intersects a core axis defined by the body.

20-22. (canceled)
